(19) United States
(12) Patent Application Publication
(10) Pub. No.: US 2009/0032725 A1
(43) Pub. Date: Feb. 5, 2009

(54) APPARATUS AND METHODS FOR TREATING A WORKPIECE USING A GAS CLUSTER ION BEAM

(75) Inventor: John J. Hautala, Beverly, MA (US)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 11/830,346

(22) Filed: Jul. 30, 2007

(51) Int. Cl. G21K 5/10

(52) U.S. Cl. 250/400; 250/492.21

(57) ABSTRACT

Embodiments of an apparatus and methods of forming isolated islands of modified material with a gas cluster ion beam are generally described herein. Other embodiments may be described and claimed.

### FIELD OF THE INVENTION

The invention relates generally to apparatus and methods for treating a workpiece with a gas cluster ion beam.

### BACKGROUND INFORMATION

Gas-cluster ion beams (GCIB's) are used for etching, cleaning, smoothing, and forming thin films. For purposes of this discussion, gas clusters are nano-sized aggregates of materials that are gaseous under conditions of standard temperature and pressure. Such gas clusters may consist of aggregates including a few to several thousand molecules, or more, that are loosely bound together. The gas clusters can be ionized by electron bombardment, which permits the gas clusters to be formed into directed beams of controllable energy. Such ionized clusters each typically carry positive charges given by the product of the magnitude of the electronic charge and an integer greater than or equal to one that represents the charge state of the cluster ion.

The larger sized ionized clusters are often the most useful because of their ability to carry substantial energy per cluster ion, while yet having only modest energy per individual molecule. The ion clusters disintegrate on impact with the workpiece. Each individual molecule in a particular disintegrated ion cluster carries only a small fraction of the total cluster energy. Consequently, the impact effects of large ion clusters are substantial, but are limited to a very shallow surface region. This makes ionized clusters effective for a variety of surface modification processes, but without the tendency to produce deeper subsurface damage that is characteristic of conventional ion beam processing.

Conventional cluster ion sources produce ionized clusters having a wide size distribution scaling with the number of molecules in each cluster that may reach several thousand molecules. Clusters of atoms can be formed by the condensation of individual gas atoms (or molecules) during the adiabatic expansion of high-pressure gas from a nozzle into a vacuum. A skimmer with a small aperture strips divergent streams from the core of this expanding gas flow to produce a collimated beam of clusters. Neutral clusters of various sizes are produced and held together by weak interatomic forces known as Van der Waals forces. This method has been used to produce beams of clusters from a variety of gases, such as helium, neon, argon, krypton, xenon, nitrogen, oxygen, carbon dioxide, sulfur hexafluoride, nitric oxide, nitrous oxide, and mixtures of these gases.

Several emerging applications for GCIB processing of workpieces on an industrial scale are in the semiconductor field. Although GCIB processing of workpieces is performed using a wide variety of gas-cluster source gases, many of which are inert gases, many semiconductor processing applications use reactive source gases, sometimes in combination or mixture with inert or noble gases, to form the GCIB.

Although GCIB processing may be used for infusing a layer of material or to correct for variations in an upper layer of a workpiece by etching, cleaning, smoothing, or deposition, conventional GCIB processing apparatus and methods do not provide for forming a plurality of isolated islands of material in a workpiece.

### BRIEF DESCRIPTION OF THE DRAWINGS

The present invention is illustrated by way of example and not as a limitation in the figures of the accompanying drawings, in which:

FIG. 1 is a diagrammatic view of one embodiment of a gas cluster ion beam apparatus to form isolated islands of material in a workpiece.

FIG. 2 is a diagrammatic view of an embodiment of a portion of a workpiece with a plurality of isolated islands of material formed in the workpiece.

FIG. 3 is a cross-sectional view taken generally along line 3-3 in FIG. 2.

FIG. 4 is a diagrammatic view similar to FIG. 2 of another embodiment of a portion of a workpiece with a plurality of isolated islands of material formed in the workpiece.

FIG. 5 is a diagrammatic view similar to FIG. 2 of another embodiment of a portion of a workpiece with a plurality of isolated islands of material formed in the workpiece.

FIG. 6 is a flow chart showing one embodiment of a method of forming a plurality of isolated islands of material in a workpiece.

FIG. 7 is a flow chart showing another embodiment of a method of forming a plurality of isolated areas in a workpiece.

### DETAILED DESCRIPTION

There is a general need for incorporating a plurality of nano-scale islands in a workpiece to modify surface or layer properties of a material, to modify a surface roughness of material, or to form seed areas for subsequent processing. One way to form a plurality of nano-scale islands in a workpiece is to use a gas cluster ion beam (GCIB) to either form a plurality of isolated islands of material derived from the GCIB or to form isolated areas of workpiece material between a plurality of islands of material derived from the GCIB. By using a GCIB to form a plurality of isolated islands, a surface of a workpiece may be modified to provide desired material properties. An apparatus and method for forming islands and isolated areas of a workpiece using a gas cluster ion beam is disclosed in various embodiments.

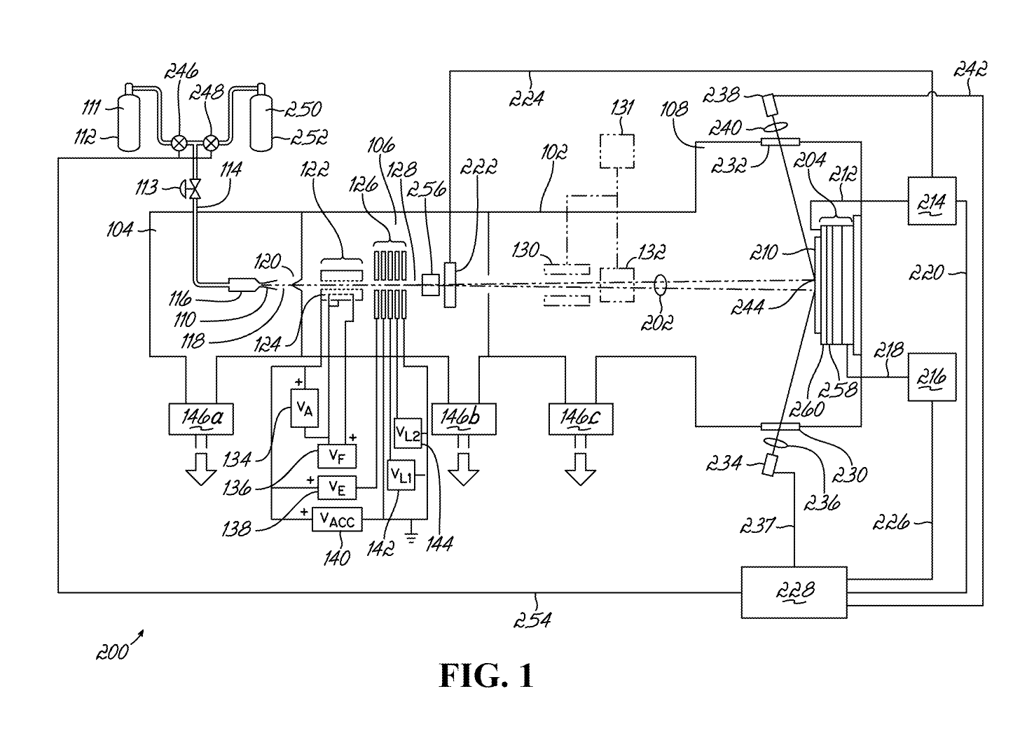

With reference to FIG. 1, a GCIB processing apparatus 200 includes a vacuum vessel 102 divided into communicating chambers that include a source chamber 104, an ionization/acceleration chamber 106, and a processing chamber 108 separated from the source chamber 104 by the ionization/acceleration chamber 106. The chambers 104, 106, 108 are evacuated to suitable operating pressures by vacuum pumping systems 146a, 146b, and 146c, respectively. A condensable source gas 111 (for example, argon (Ar), carbon dioxide (CO₂), oxygen (O₂), or nitrogen (N₂)) stored in a source gas cylinder 112 is admitted under pressure through a gas metering valve 113 and a gas feed tube 114 into a stagnation chamber 116. The source gas is subsequently ejected from the stagnation chamber 116 into the substantially lower pressure vacuum inside the source chamber 104 through a properly shaped nozzle 110. A gas jet 118 results inside the source chamber 104. Cooling, which results from the rapid expansion of the gas jet 118, causes a portion of the gas jet 118 to condense into clusters, each consisting of from several to several thousand weakly bound atoms or molecules.

A gas skimmer aperture 120 situated between the source chamber 104 and ionization/acceleration chamber 106 partially separates any gas molecules that have not condensed into clusters from those that have condensed and become part of the gas jet 118. The removal of the un-condensed gas molecules minimizes pressure perturbations in the downstream regions where such higher pressures would be detrimental, such as in the ionization/acceleration chamber 106 near ionizer 122 and high voltage electrodes 126 and in the process chamber 108.

After the gas jet 118 has been formed in the source chamber 104, the constituent gas clusters in gas jet 118 are ionized by ionizer 122. The ionizer 122 is typically an electron impact ionizer that produces electrons from one or more filaments 124 and accelerates and directs the electrons causing them to collide with the gas clusters in the gas jet 118 inside the ionization/acceleration chamber 106. The electron impact ejects electrons from molecules in the gas clusters to generate ionized molecules and thereby endows the gas clusters with a net positive charge to define ionized clusters. A filament power supply 136 provides voltage V_{F} to heat the ionizer filament 124.

A set of suitably biased high voltage electrodes 126 in the ionization/acceleration chamber 106 extracts the ionized clusters from the ionizer 122. The high voltage electrodes 126 then accelerate the extracted ionized clusters to a desired energy and focus them to define the GCIB 128. The ionized clusters in GCIB 128 are typically accelerated with an accelerating potential in the range of about one kilovolt (kV) to several tens of kV's. Anode power supply 134 provides voltage V_{A} for accelerating electrons emitted from filament 124 and causing the electrons to bombard the gas clusters in gas jet 118, which produces ionized clusters.

Extraction power supply 138 biases at least one of the high voltage electrodes 126 with respect to the ionizer 122 for extracting and focusing the GCIB 128. Accelerator power supply 140 provides voltage V_{Acc} to bias one of the high voltage electrodes 126 with respect to the ionizer 122 so as to result in a total GCIB acceleration energy equal to V_{Acc} electron volts (eV). Lens power supplies 142,144 may be provided to bias some of the high voltage electrodes 126 with potentials (e.g., V_{L1} and V_{L2}) to focus the GCIB 128. A beam filter 256 in the ionization/acceleration chamber 106 eliminates monomers or monomers and light ionized clusters from the GCIB 128 to define a GCIB 202 that enters the processing chamber 108.

An adjustable aperture may be incorporated with the beam filter 256 or included as a separate device (not shown), to throttle or variably block a portion of a gas cluster ion beam flux thereby reducing the GCIB beam current to a desired value. The adjustable aperture may be employed alone or with other devices and methods known to one skilled in the art to reduce the gas cluster ion beam flux to a very small value including varying the gas flow from a GCIB source supply; modulating the ionizer by either varying a filament voltage V_{F} or varying an anode voltage V_{A}; or modulating the lens focus by varying lens voltages V_{L1} and/or V_{L2}.

A beam gate 222 is disposed in the path of GCIB 128 in the ionization/acceleration chamber 106. Beam gate 222 has an open state in which the GCIB 128 is permitted to pass from the ionization/acceleration chamber 106 to the processing chamber 108 to define GCIB 202 and a closed state in which the GCIB 128 is blocked from entering the processing chamber 108. A control cable 224 conducts control signals from dosimetry processor 214 to beam gate 222. The control signals controllably switch beam gate 222 to between the open or closed states.

A workpiece 210, which may be a semiconductor wafer or other substrate to be processed by GCIB processing, is disposed in the path of the GCIB 202 in the processing chamber 108 using a handler (not shown). Because most applications contemplate the processing of large workpieces 210 with spatially uniform results, a scanning system may be desirable to uniformly scan the GCIB 202 across large areas.

The GCIB 202 directed at the workpiece 210 may be substantially stationary (i.e., un-scanned). Workpiece 210 is held in the processing chamber 108 on a X-Y positional support 204 operable to move the workpiece 210 in two axes, effectively scanning the workpiece 210 relative to the GCIB 202. The GCIB 202 impacts the workpiece 210 at a projected impact region 244 on a surface of the workpiece 210. By X-Y motion, the X-Y positional support 204 can position each portion of a surface of the workpiece 210 in the path of GCIB 202 so that every region of the surface may be made to coincide with the projected impact region 244 for processing by the GCIB 202.

An X-Y controller 216 provides electrical signals to the X-Y positional support 204 through an electrical cable 218 for controlling the position and velocity in each of X-axis and Y-axis directions. The X-Y controller 216 receives control signals from, and is operable by, system controller 228 through an electrical cable 226. X-Y positional support 204 moves by continuous motion or by stepwise motion according to conventional X-Y table positioning technology to position different regions of the workpiece 210 within the projected impact region 244. In one embodiment, X-Y positional support 204 is programmably operable by the system controller 228 to scan, with programmable velocity, any portion of the workpiece 210 through the projected impact region 244 for GCIB processing by the GCIB 202.

Alternatively, orthogonally oriented electrostatic scan plates 130,132 can be utilized to produce a raster or other scanning pattern of the GCIB 202 across the desired processing area on workpiece 210, instead of or in addition to using X-Y positional support 204. When beam scanning is performed, a scan generator 131 provides X-axis and Y-axis scanning signal voltages to the scan plates 130, 132. The scanning signal voltages are commonly triangular waves of different frequencies that cause the GCIB 202 to scan the surface of workpiece 210.

The workpiece holding surface 260 of X-Y positional support 204 is electrically conductive and is connected to a dosimetry processor 214 by an electrical lead 212. An electrically insulating layer 258 of X-Y positional support 204 isolates the workpiece 210 and workpiece holding surface 260 from the other portions of the X-Y positional support 204. Electrical charge induced in the workpiece 210 by the impinging GCIB 202 is conducted through workpiece 210, workpiece holding surface 260, and electrical lead 212 to the dosimetry processor 214 for measurement. Dosimetry processor 214 has integrating means for integrating the GCIB current to determine a GCIB processing dose. Under certain circumstances, a target-neutralizing source (not shown) of electrons, sometimes referred to as electron flood, may be used to neutralize the GCIB 202. In such case, a Faraday cup (not shown) may be used to assure accurate dosimetry despite the added source of electrical charge.

The processing chamber 108 includes optical windows 230 and 232. An optical transmitting transducer 234, which may also have additional transmitting optics 236, and an optical receiving transducer 238, which may also have additional receiving optics 240, form a conventional optical instrumentation system. The transmitting transducer 234 receives, and is responsive to, controlling electrical signals from the system controller 228 communicated through an electrical cable 246. The transmitting transducer 234 directs an optical beam through the optical window 230 toward the workpiece 210. The receiving transducer 238 detects the optical beam, after interaction with workpiece 210, through optical window 232. The receiving transducer 238 sends measurement signals to the system controller 228 through an electrical cable 242.

In addition to gas cylinder 112, the GCIB processing apparatus 200 has a second gas cylinder 252 for containing a reactive gas 250, that may be, for example, oxygen, nitrogen, carbon dioxide, nitric oxide, nitrous oxide, another oxygen-containing condensable gas, or sulfur hexafluoride. Shut-off valves 246 and 248 are operable by signals transmitted through electrical cable 254 by system controller 228 to select either condensable source gas 111 or source gas 250 for GCIB processing.

The dosimetry processor 214 may be one of many conventional dose control circuits that are known in the art and may include, as a part of its control system, all or part of a programmable computer system. The X-Y controller 216 may include as part of its logic all, or part of, a programmable computer system. The dosimetry processor 214 may include as part of its logic all, or part of, a programmable computer system. Some or all of the logic of the X-Y controller 216 and dosimetry processor 214 may be performed by a small general purpose computer that also controls other portions of the GCIB processing apparatus, including the system controller 228.

In operation, the dosimetry processor 214 signals the opening of the beam gate 222 to irradiate the workpiece 210 with the GCIB 202. The dosimetry processor 214 measures the GCIB current collected by the workpiece 210 to compute the accumulated dose received by the workpiece 210. When the dose received by the workpiece 210 reaches a predetermined required dose, the dosimetry processor 214 closes the beam gate 222 and processing of the workpiece 210 is complete.

The dosimetry processor 214 is electrically coupled with the system controller 228 by an electrical cable 220. During processing of the workpiece 210, the dose rate is communicated by the dosimetry processor 214 to the system controller 228 by electrical signals transmitted over electrical cable 220. The system controller 228 analyzes the electrical signals to, for example, confirm that the GCIB beam flux is substantially constant or to detect variations in the GCIB beam flux. The X-Y controller 216 is responsive to electrical signals from the system controller 228 that are transmitted over an electrical cable 226. The X-Y controller 216 can scan the X-Y positional support 204 to position every part of the workpiece 210 for processing according to a set of predetermined parameters.

As an alternative method, the GCIB 202 may be scanned at a constant velocity in a fixed pattern across the surface of the workpiece 210, but the GCIB intensity is modulated (often referred to as Z-axis modulation) to deliver an intentionally non-uniform dose to the sample. The GCIB intensity or beam flux may be modulated by any of a variety of methods, including varying the gas flow from a GCIB source supply; modulating the ionizer by either varying a filament voltage V_{F} or varying an anode voltage V_{A}; modulating the lens focus by varying lens voltages V_{L1} and/or V_{L2}; or mechanically blocking a portion of the beam with a variable beam block, adjustable shutter, or adjustable aperture. The modulating variations may be continuous analog variations or may be time modulated switching or gating.

In one embodiment, gas clusters from the GCIB 202 may comprise inert species originating from gas sources such as argon (Ar), neon (Ne), krypton (Kr), and xenon (Xe). For example, an ionized Ar gas cluster ion may impinge a surface of a workpiece 210 and form a shallow impact crater with a width of approximately 20 nm and a depth of approximately 10 nm, but less than approximately 25 nm. When imaged using a nano-scale imaging device such as Atomic Force Microscopy (AFM), the impact craters have an appearance similar to indentations. After impact, the inert species from the gas cluster ion vaporizes, or escapes the surface of the workpiece 210 as a gas and is exhausted from the processing chamber 108 by the vacuum pumping systems 146a, 146b, and 146c. The composition of the workpiece 210 is not modified by the indentations.

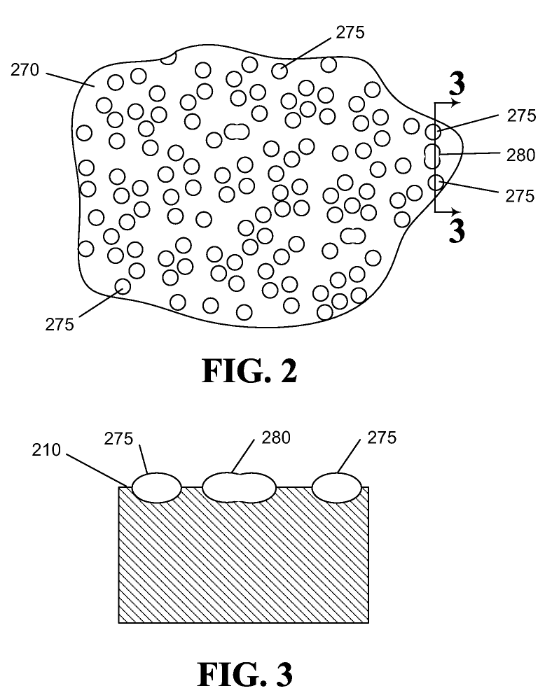

With reference to FIGS. 2 and 3, a plurality of isolated islands 275, 280 are formed in a portion 270 of the workpiece 210 using the GCIB 202 (FIG. 1). The islands 275, 280 are isolated because each is surrounded by non-modified material of the workpiece 210. As a result, the islands 275, 280 define isolated regions of modified material produced by the bombardment of one or more individual gas clusters into the target material of the workpiece 210, which results in the intermixing of at least one of the cluster constituents and the target material of the workpiece 210.

In this embodiment, the GCIB 202 is directed at a workpiece 210. The ionized clusters of the GCIB 202 impinge the workpiece 210 with a spatial distribution across a surface of workpiece 210 to form the islands 275, 280 through an infusion process. The distribution of the ionized clusters striking the surface of the workpiece 210 may be a stochastic distribution such that the islands 275, 280 are formed randomly or in a non-ordered pattern. Each of the islands 275 is formed because of an infusion of a single gas cluster ion on the surface of the workpiece 210. In contrast, island 280 is formed because of an infusion of two or more ionized clusters that impinged the surface in an overlapping manner. The islands 275, 280 are separated from one another by non-modified regions containing the target material of the workpiece 210. Islands formed because of an infusion of a single gas cluster ion, such as islands 275, may be approximately the same size.

A width of a single island formed from a single gas cluster ion, where width is measured along the plane of a surface of the workpiece 210, may be proportional to the accelerating potential of the GCIB to the ⅓ power (E^{1/3}), though other parameters, such as an aggregate size of a gas cluster ion, workpiece material type, and gas cluster ion type, may also minimally influence the size and shape of each individual island 275. For example, an oxygen gas cluster ion accelerated with an accelerating voltage of about 30 kV impinging a silicon workpiece 210 may result in islands 275 characterized by a 10 nanometer (nm) width. As a result, the use of a consistent GCIB energy may result in a very small size distribution for single islands 275 formed in the surface of the workpiece 210. In one embodiment, a depth of each island 275 is about 25 nm or less, where the depth is measured from the surface of the workpiece 210 to a bottom edge of the island 275 most remote from the surface. In one embodiment, a width of each of the islands 275, 280 may be between about 5 nm and about 100 nm. The width of the islands 275, 280 can range from about 5 nm to about 20 nm or, alternatively, from about 5 nm to about 50 nm.

As best shown in FIG. 3, ionized clusters comprising a reactive species may impinge the surface of the workpiece 210 and react with material in close proximity to an impingement site to form islands 275. A gas cluster ion may slightly penetrate the surface of the workpiece 210 and create enough heat to initiate a chemical reaction between a reactive species and the material of workpiece 270. The composition of the islands 275 contains one or more elements from the reactive species in the ionized clusters of the GICB 202 and one or more elements from the material of the workpiece 210.

In one embodiment, gas clusters from the GCIB contain reactive species originating from gas sources such as oxygen (O₂), nitrogen (N₂), and methane (CH₄). For example, the workpiece 210 may contain silicon and a reactive species such as oxygen used to generate a gas cluster ion may impinge the surface of the workpiece portion 270 to form island 275 of silicon dioxide SiO₂. As another example, the workpiece 210 may contain silicon and a reactive species, such as nitrogen, used to generate a gas cluster ion may impinge the surface of the workpiece portion 270 to form island 275 of silicon nitride Si₃N₄.

In an alternative embodiment, the ionized clusters in the GCIB 202 directed to impact the surface of the workpiece portion 270 may be formed from a deposition species rather than a reactive species. For example, gas clusters from the GCIB 202 may contain deposition species originating from gas sources, such as germane (GeH₄) and silane (SiH₄). A deposition species is a species that is soluble in the material of workpiece 210, but does not necessarily react with the material constituting workpiece 210. In this embodiment, the composition of the islands 275 contains one or more elements from the deposition species in the ionized clusters of the GICB 202 and one or more elements from the material constituting the workpiece 210.

For example, the workpiece 210 may contain silicon and a deposition species, such as germanium, may be used to generate a gas cluster ion directed to impinge the surface of the workpiece portion 270 to form island 275 of silicon germanium (SiGe). In another example, the workpiece 210 may contain nickel and a deposition species, such as silicon, may be used to generate a gas cluster ion directed to impinge the surface of the workpiece portion 270 to form island 275 of silicon (Si) or nickel silicide (Ni₂Si).

In an alternative embodiment, the islands 275 may be further embedded in the workpiece 210 by depositing a layer of material (not shown) over the surface of the workpiece 210 to cover the exposed islands 275. The layer of material may be deposited or formed using a method, such as a form of chemical vapor deposition (CVD), physical vapor deposition (PVD), GCIB processing, spin-on processing, or other deposition methods known to one skilled in the art. The layer of material may be the same as, or different from, the material of workpiece 210 at the surface containing the islands 275. Embedding the material in islands 275 below the workpiece surface may enhance the surface or bulk properties of the workpiece 210.

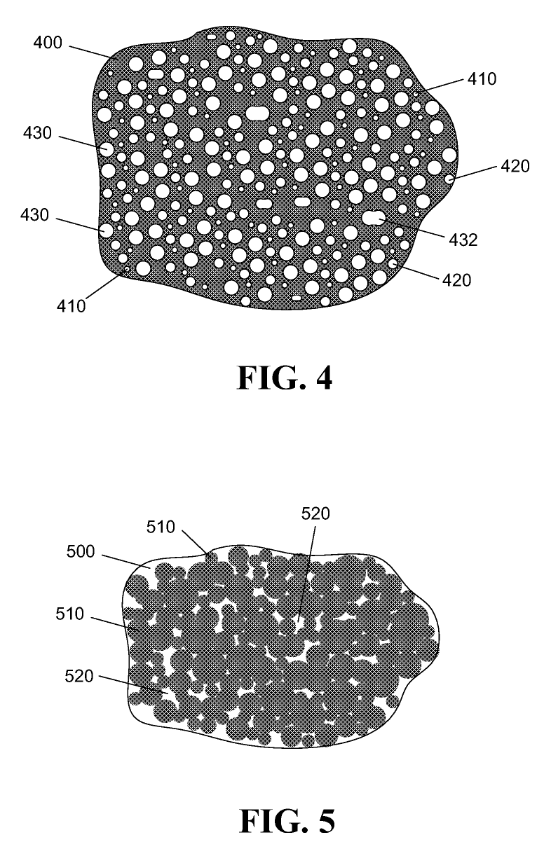

With reference to FIG. 4 and in another embodiment, a plurality of isolated islands 410, 420, 430, and 432 are formed in a portion of a workpiece 400. In this embodiment, the GCIB 202 (FIG. 1) at a first energy is directed at the workpiece 400. The ionized clusters of the GCIB 202 impinge the workpiece 210 with a spatial distribution across a surface of workpiece 210 to form the islands 410 through an infusion process.

The plurality of islands 410 may be formed on an entire workpiece 210 or, alternatively, on only a portion 400 of the workpiece 210 by either controlling the GCIB to strike only the workpiece portion 400 or by partially masking the workpiece 210 to exposed only the workpiece portion 400 and any similar unmasked portions (not shown). The workpiece 210 may be partially masked using a soft mask or a hard mask, as known to one skilled in the art, to define masked portions and unmasked portions, such as portion 400. A GCIB at a second energy, which is selected to be greater than the first energy, is directed at the same workpiece portion 400 to form a spatially-distributed plurality of larger islands 420. Similarly, a GCIB at a third energy, which is selected to be greater than the second energy, is directed at the same workpiece portion 400 to form a spatially-distributed plurality of islands 430 that are larger in size than the islands 410, 430. The composition of GCIB 202 used to form each of the islands 410, 420, 430 can be the same or each GCIB composition can be different.

Islands 410, 420, 430 are each formed because of an infusion of a single gas cluster ion on the surface of the workpiece 210. Island 432 is formed because of an infusion of two ionized clusters at a third energy that with locations of impact on the surface of the workpiece 210 that overlap with each another. Each island 410, 420, 430, 432 is separate from one another, which forms isolated islands in the surface of the workpiece portion 400. Further, each of the islands 410, 420, 430, 432 may act as a nucleation site for a subsequent process. A width of a single island formed from a single gas cluster ion, where width is measured along the plane of a surface of the workpiece portion 400, is roughly proportional to the accelerating potential applied to the GCIB to the ⅓ power (E^{1/3}). Ionized clusters accelerated with higher accelerating potentials may result in wider islands, as visible in FIG. 4.

The workpiece 210 may be annealed after impinging the workpiece portion 400 with the GCIB 202 to form the islands 410, 420, 430, 432. Specifically, the workpiece 210 may be annealed using a diffusion furnace, a lamp-based rapid thermal processing system, a laser anneal system, or another system capable of diffusing material from island 410 into a material of the workpiece portion 400, material from the workpiece portion 400 into a material from the island 410, and to activate chemical reactions between material from the island 410 and the workpiece portion 400. In one embodiment, the workpiece 210 may be annealed up to a maximum temperature of approximately 200° C. In another embodiment, the workpiece 210 may be annealed up to a maximum temperature of approximately 500° C. In a further embodiment, the workpiece 210 may be annealed up to a maximum temperature of approximately 1200° C.

With reference to FIG. 5 and in another embodiment, a plurality of islands 510 are formed in a portion of a workpiece 500. In one embodiment, workpiece 500 may be a wafer in the context of semiconductor manufacturing with or without layers and structures formed on the wafer. In another embodiment, the workpiece 500 may be a metal or ceramic structure. However, the embodiment is not limited to rigid high-melting point structures. The workpiece 500 may also be an elastomer, a plastic, or other pliable structure capable of withstanding a low vacuum atmosphere, such as the processing chamber 108 in the GCIB processing apparatus 200, and compatible with a vacuum environment. The portion of the workpiece 500 in FIG. 5 is infused with a plurality of islands 510 with a plurality of isolated regions or areas 520 remaining between the islands 510. The isolated areas 520 are locations on the workpiece surface where one of the islands 510 has not been formed and which substantially retain the composition of the material of the workpiece 500. Effectively, the isolated areas 520 represent substantially unmodified regions dispersed between and among the plurality of islands 510.

In one embodiment, the isolated areas 520 may be nano-scale workpiece surfaces distributed across the surface of the portion of the workpiece 500 and that remain exposed after formation of islands 510. The isolated areas 520 may be used for subsequent processes. For example, the workpiece 500 may be contain nickel (Ni) and islands 510 containing silicon (Si) may be formed in the workpiece 500 to form a plurality of isolated areas 520 of Ni that may be used as nucleation sites for the growth of carbon nanotubes using a growth process like CVD.

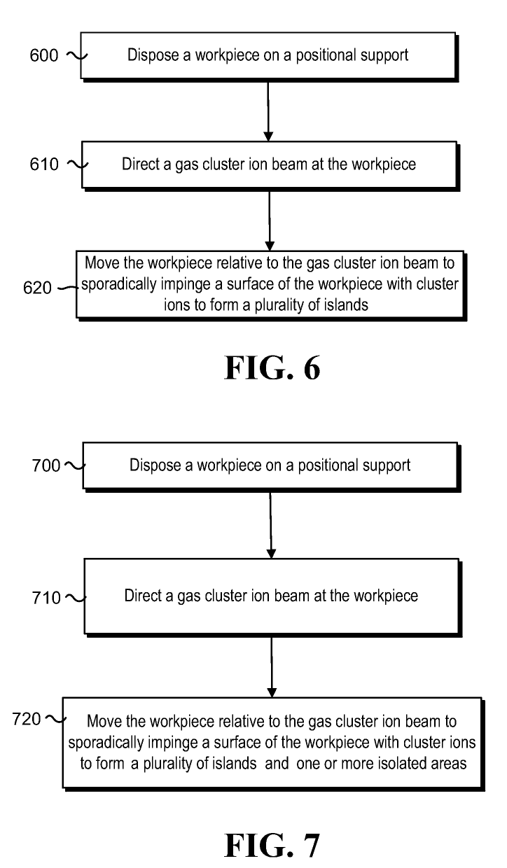

FIG. 6 is a flow chart depicting one embodiment of a method of forming a plurality of isolated islands in a workpiece. In block 600, a workpiece 210 is disposed on the X-Y positional support 204 (FIG. 1). The workpiece 210 may be disposed on the X-Y positional support 204 using an automated handler such as a multi-axis robot or by other automated means. In block 610, the GCIB 202 (FIG. 1) is directed at the workpiece 210. A gas cluster ion beam flux may be directed to impinge the surface of the workpiece 210 at a stochastically distributed plurality of locations. The GCIB 208 may be accelerated with an accelerating voltage of between about 500 volts (V) and about 200 kV, depending on the desired island size. In one embodiment, the GCIB 202 impinges the surface of the workpiece 210 in a spatial distribution with a dose or areal density (i.e., the number of ionized clusters per unit area) of between about 5×10⁹ and about 2×10¹⁰ ions per square centimeter (ions/cm²). In another embodiment, the areal density may be between about 1×10⁸ and about 5×10⁹ ions/cm² In yet another embodiment, the areal density may be between about 2×10¹⁰ ions/cm² and about 5×10¹⁰ ions/cm². In block 620, the workpiece 210 is moved relative to the GCIB 202 or, alternatively, the GCIB 202 may be scanned relative to the workpiece 210 to impinge the surface of the workpiece 210 with ionized clusters from the GBIB 202 and, thereby, form a plurality of islands upon the conclusion of the GCIB treatment of workpiece 210.

FIG. 7 is a flow chart depicting another embodiment of a method of forming a plurality of isolated areas 520 on workpiece 500 (FIG. 5). In block 700, the workpiece 500 is disposed on the X-Y positional support 204 (FIG. 1). In block 710, the GCIB 202 (FIG. 1) is directed at the workpiece 500. A gas cluster ion beam flux may be directed to impinge the surface of a workpiece 500. The GCIB 202 may be accelerated with an acceleration potential between about 500 V and about 200 keV, which at least partially determines the island size. In one embodiment, the GCIB 202 impinges the surface of the workpiece 500 with an areal density or spatial distribution of between about 1×10¹⁰ and about 2×10¹⁰ ions/cm². In another embodiment, the areal density may be between about 2×10¹⁰ ions/cm² and about 1×10¹¹ ions/cm². In yet another embodiment, the areal density may be between about 1×10¹¹ ions/cm² and about 1×10¹⁵ ions/cm². In block 720, the workpiece 500 is moved relative to the GCIB 202 or, alternatively, the GCIB 202 may be scanned relative to the workpiece 500 to impinge the surface of the workpiece 500 with ionized clusters and, thereby, define one or more isolated areas 520 (FIG. 5) between the islands 510 when the GCIB treatment of the workpiece 500 is concluded.

The exemplary compositions for the islands 410, 420, 430, 432, 510 contained herein may be stoichiometric, non-stoichiometric, or a combination of stoichiometric and non-stoichiometric without limitation as understood by a person having ordinary skill in the art. For example, islands 410, 420, 430, 432, 510 composed of silicon nitride may have a composition that is stoichiometric Si₃N₄, a non-stoichiometric composition SiₓN_{y} that is enriched either in silicon or nitrogen, or may comprise a combination of stoichiometric and non-stoichiometric compositions. In various embodiments, the compositions may be doped with elements or compounds other than the primary constituents. The term “infusion” refers to a modification process distinguishable from an ion implantation process, as detailed for example in U.S. Publication No 2005/0181621 which is hereby incorporated by reference herein in its entirety.

An apparatus and method for incorporating a plurality of nano-scale islands in a workpiece is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A method of treating a workpiece using a gas cluster ion beam, the method comprising:
moving the workpiece and the gas cluster ion beam relative to each other; and
impinging a surface of the workpiece with ionized clusters of the gas cluster ion beam to form, after treatment is concluded, a plurality of islands that are spatially distributed across the surface.

2. The method of claim 1, wherein the gas cluster ion beam comprises ionized clusters containing an inert species and a reactive species.

3. The method of claim 1, wherein the gas cluster ion beam comprises ionized clusters containing an inert species and a deposition species.

4. The method of claim 3, wherein the plurality of islands have a composition that includes one or more elements from the deposition species.

5. The method of claim 1, further comprising:
annealing the workpiece to incorporate material from the workpiece into the plurality of islands.

6. The method of claim 1, wherein the plurality of islands define nucleation sites for a subsequent process.

7. The method of claim 1, wherein a width of each of the plurality of islands is between about 5 nm and about 50 nm.

8. The method of claim 1, further comprising:
partially masking the workpiece to define the surface of the workpiece impinged with the ionized clusters.

9. A method of treating a workpiece using a gas cluster ion beam, the method comprising:
moving the workpiece and the gas cluster ion beam relative to each other; and
impinging a surface of the workpiece with ionized clusters of the gas cluster ion beam to form, after treatment is concluded, a plurality of islands spatially distributed across the surface and one or more substantially unmodified regions between the plurality of islands.

10. The method of claim 9, further comprising:
throttling the gas cluster ion beam to reduce a fluid of the gas cluster ion beam.

11. The method of claim 10, wherein the plurality of isolated areas define nucleation sites for a subsequent process.

12. The method of claim 9, further comprising:
partially masking the workpiece to define the surface of the workpiece impinged with the ionized clusters.

13. The method of claim 9, wherein a width of each of the plurality of islands is between about 5 nm and about 50 nm.

14. The method of claim 9, wherein a thickness of each of the plurality of islands is between about 5 nm and about 50 nm.

15. A method of treating a workpiece using a gas cluster ion beam, the method comprising:
moving the workpiece and the gas cluster ion beam relative to each other; and
impinging a surface of the workpiece with ionized clusters to form a plurality of indentations in the surface.

16. The method of claim 15, wherein each of said indentations has a depth measured relative to the surface of between about 2 nm and about 25 nm.

17. The method of claim 15, wherein the gas cluster ion beam comprises ionized clusters containing an inert species.

18. The method of claim 17, wherein the surface of the workpiece has a composition that is not modified by the impingement of the ionized clusters, and further comprising:
vaporizing the ionized clusters, after the indentations are formed, to release the inert species from the surface.

19. A gas cluster ion beam apparatus for treating a workpiece using a gas cluster ion beam, the gas cluster ion beam apparatus comprising:
a vacuum vessel;
a gas cluster ion beam source within the vacuum vessel, the gas cluster ion beam source configured to produce the gas cluster ion beam; and
a positional support configured for controllably producing relative scanning motion between the workpiece and the gas cluster ion beam so that ionized clusters of the gas cluster ion beam impinge a surface of the workpiece at a plurality of spaced apart locations to form, after treatment is concluded, a plurality of islands.

20. The gas cluster ion beam apparatus of claim 19, further comprising:
an adjustable aperture configured to reduce a gas cluster ion beam flux.

21. The gas cluster ion beam apparatus of claim 19, wherein the positional support controllably is configured to produce relative scanning motion along a first axis.

22. The gas cluster ion beam apparatus of claim 20, further comprising:
a plurality of electrostatic scan plates configured to controllably scan the gas cluster ion beam along a second axis different than the first axis.
